(19) United States
(12) Patent Application Publication
(10) Pub. No.: US 2014/0269659 A1
(43) Pub. Date: Sep. 18, 2014

(54) METHOD AND APPARATUS FOR SEGMENTATION OF MODULATION CODING SCHEME

(71) Applicant: QUALCOMM Incorporated, San Diego, CA (US)

(72) Inventor: Maarten Menzo WENTINK, Naarden (NL)

(73) Assignee: QUALCOMM INCORPORATED, San Diego, CA (US)

(21) Appl. No.: 14/208,897

(22) Filed: Mar. 13, 2014

Related U.S. Application Data
(60) Provisional application No. 61/781,782, filed on Mar. 14, 2013.

(51) Int. Cl. H04W 28/06; H04W 4/00

(52) U.S. Cl. CPC H04W 28/065; H04W 4/008
USPC 370/338

(57) ABSTRACT

Certain aspects of the present disclosure relate to techniques for segmentation of modulation and coding scheme (MCS) for data transmission. A frame with a header and a data unit can be generated, wherein a field of the frame indicates the data unit being split into segments associated with different MCSs. Further, a frame with a plurality of symbols can be generated, each symbol comprises one or more data units, wherein one or more fields in the one or more data units of that symbol indicate MCS of another symbol of the plurality of symbols immediately following that symbol.

### CROSS-REFERENCE TO RELATED APPLICATIONS

The present Application for Patent claims priority to U.S. Provisional Application No. 61/781,782, filed Mar. 14, 2013, which is assigned to the assignee of the present application and hereby expressly incorporated by reference herein in its entirety.

### BACKGROUND

1. Field

Certain aspects of the present disclosure generally relate to wireless communications and, more particularly, to segmentation of modulation and coding scheme (MCS) for data transmission.

2. Background

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide an apparatus for wireless communications. The apparatus generally includes circuitry configured to generate a frame with a header and a data unit, wherein a field of the frame indicates the data unit being split into segments associated with a different modulation coding schemes (MCSs), and a transmitter configured to transmit the frame.

Certain aspects of the present disclosure provide a method for wireless communications. The method generally includes generating frame with a header and a data unit, wherein a field of the frame indicates the data unit being split into segments associated with a different modulation coding schemes (MCSs), and transmitting the frame.

Certain aspects of the present disclosure provide an apparatus for wireless communications. The apparatus generally includes means for generating a frame with a header and a data unit, wherein a field of the frame indicates the data unit being split into segments associated with a different modulation coding schemes (MCSs), and means for transmitting the frame.

Certain aspects of the present disclosure provide a computer program product for wireless communications, comprising a computer readable medium having instructions stored thereon for generating a frame with a header and a data unit, wherein a field of the frame indicates the data unit being split into segments associated with a different modulation coding schemes (MCSs), and transmitting the frame.

Certain aspects of the present disclosure provide a wireless node. The wireless node generally includes at least one antenna, circuitry configured to generate a frame with a header and a data unit, wherein a field of frame indicates the data unit being split into segments associated with different modulation coding schemes (MCSs), and a transmitter configured to transmit, via the at least one antenna, the frame.

Certain aspects of the present disclosure provide an apparatus for wireless communications. The apparatus generally includes circuitry configured to generate a frame with a plurality of symbols, each symbol comprises one or more data units, wherein one or more fields in the one or more data units of that symbol indicate modulation coding scheme (MCS) of another symbol of the plurality of symbols immediately following that symbol, and a transmitter configured to transmit the frame.

Certain aspects of the present disclosure provide a method for wireless communications. The method generally includes generating a frame with a plurality of symbols, each symbol comprises one or more data units, wherein one or more fields in the one or more data units of that symbol indicate modulation coding scheme (MCS) of another symbol of the plurality of symbols immediately following that symbol, and transmitting the frame.

Certain aspects of the present disclosure provide an apparatus for wireless communications. The apparatus generally includes means for generating a frame with a plurality of symbols, each symbol comprises one or more data units, wherein one or more fields in the one or more data units of that symbol indicate modulation coding scheme (MCS) of another symbol of the plurality of symbols immediately following that symbol, and means for transmitting the frame.

Certain aspects of the present disclosure provide a computer program product for wireless communications, comprising a computer readable medium having instructions stored thereon for generating a frame with a plurality of symbols, each symbol comprises one or more data units, wherein one or more fields in the one or more data units of that symbol indicate modulation coding scheme (MCS) of another symbol of the plurality of symbols immediately following that symbol, and transmitting the frame.

Certain aspects of the present disclosure provide a wireless node. The wireless node generally includes at least one antenna, circuitry configured to generate a frame with a plurality of symbols, each symbol comprises one or more data units, wherein one or more fields in the one or more data units of that symbol indicate modulation coding scheme (MCS) of another symbol of the plurality of symbols immediately following that symbol, and a transmitter configured to transmit the frame via the at least one antenna.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example of PHY Protocol Data Unit (PPDU) with a modulation coding scheme (MCS) segmentation field included in a service field of the PPDU in accordance with certain aspects of the present disclosure.

FIG. 5 illustrates example operations for MCS segmentation in accordance with certain aspects of the present disclosure.

FIG. 5A illustrates example means capable of performing the operations shown in FIG. 5.

FIG. 6 illustrates other example operations for MCS segmentation in accordance with certain aspects of the present disclosure.

FIG. 6A illustrates example means capable of performing the operations shown in FIG. 6.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a node comprises a wireless node. Such wireless node may provide, for example, connectivity for or to a network (e.g., a wide area network such as the Internet or a cellular network) via a wired or wireless communication link. In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium.

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

FIG. 3 illustrates various components that may be utilized in a wireless device 302 that may be employed within a wireless communication system (e.g., system 100 of FIG. 1). The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Certain types of transmissions (e.g., in accordance with the IEEE 802.11 standard) may depend on temporal information, such as sounding data. One possible property of such data is that it may lose its freshness (e.g., the data may be not current) as time elapses, causing it to become less valuable.

In practice, the fact that certain information (e.g., sounding data) may become less fresh implies that subsequent transmissions may have to use a reduced Modulation Coding Scheme (MCS) in order to have an acceptable packet error rate. Using a reduced MCS may mean sending data in multiple packets (where a single packet may have been sufficient with a higher MCS), which implies overhead due to an inter-frame space and a PHY header.

Currently, the entire data field of a PHY Protocol Data Unit (PPDU) is sent at a single MCS. This MCS is signaled in the PHY Layer Convergence Protocol (PLCP) header of the PPDU.

### MCS Segmentation Field

Certain aspects of the present disclosure, however, allow the MCS to change during the Data field of the PPDU (rather than require a single MCS). Signaling may be provided (e.g., in the PLCP header or in the Data field) to indicate how the Data field is partitioned into MCS segments. In certain implementations, the boundaries between MCS segments (segments of the data field with different MCS) may be restricted to symbol boundaries. In other words, in such cases, a change in MCS may only occur in from one symbol to the next, not within a single symbol. MAC Protocol Data Units (MPDUs) that are contained inside the Data field may cross symbol boundaries and, therefore, may be transmitted with multiple MCSs.

As used herein, MCS may generally be denoted (indicated) by a High Throughput (HT) MCS index or a Very High Throughput Modulation Coding Scheme (VHT-MCS) index (with different index values mapped to different MCSs). When an MCS is referred to herein as being “one less” than another MCS, this generally means that the HT/VHT MCS index is one less than the other HT/VHT MCS index. For an HT-MCS, the MCS index may be lower bounded within the bandwidth, Number of Spatial Streams (Nss), and Number of BCC encoders for the Data field (Nes) category. A VHT-MCS index may never less than 0. In such cases, if a lower MCS is not possible, the same MCS is denoted.

As illustrated in FIG. 4, one approach to signal MCS segmentation within a data field 420 of a PPDU 400 is to define one or more bits inside a Service field 422 of the Data field 420 (the one or more bits may be referred to as an MCS segmentation field). As an alternative, the MCS segmentation field may also be included in Signal (SIG) field of the PLCP header 410.

As an example, a 1-bit MCS segmentation field set to 0 may indicate that the Data field 420 is transmitted at a single MCS, for example, with the value of the MCS signaled in the PLCP header 410. On the other hand, the 1-bit MCS segmentation field set to 1 may indicate that the Data field 420 is split into (at least) two MCS segments: MCS segment 1 426 and MCS segment 2 428.

The PLCP header 410 may signal the total number of symbols (SYM) of the Data field 420. Assuming 2 MCS segments, as shown in FIG. 4, the first MCS segment 426 may comprise |SYM/2| symbols, where |x| denotes rounding to the nearest integer. The second MCS segment 428 may comprise the remaining symbols. The MCS of the first MCS segment 426 may be signaled in the PLCP header. In some cases, the MCS of the subsequent MCS segments (e.g., MCS segment 428 and on, if more than 2) may be predetermined, based on the MCS of the first segment 426. For example, the MCS of each subsequent segment may be one less than the MCS of the immediately preceding MCS segment. As illustrated, an PSDU 424 may span a border between MCS segments 426 and 428 (which may be limited to borders between symbols). Thus, different MCS may be used within the same PSDU 424.

Of course, the segmentation field may indicate any number of MCS segments. For example, the MCS segmentation field may indicate that the Data field is split into three MCS segments, with size |SYM/3| (except the last segment, which contains the remaining symbols of the Data field). As described above, the MCS of the first MCS segment may be signaled in the PLCP header and the MCS of the subsequent MCS segments may be one less than the MCS of the immediately preceding MCS segment.

To generalize, the MCS segmentation field may indicate that the Data field is split into N MCS segments, with size |SYM/N| except the last segment, which contains the remaining symbols of the Data field. As descrsibed above, the MCS of the first MCS segment may be signaled in the PLCP header and the MCS of the subsequent MCS segments may be one less than the MCS of the immediately preceding MCS segment. The value of N may be either defined in the standard, or agreed upon when setting up a link between the stations (STAs, wireless nodes), wherein the link may be established during association or a direct link. Alternatively, the value of N (number of segments) may be included in the MCS segmentation field itself, which may be comprised of multiple bits in this case.

In some cases, MCS segmentation may be signaled by defining a 1-bit (or multi-bit) MCS segmentation field in the MPDU delimiter. In this case, the MCS segmentation field set to 0 may indicate that the MCS of the symbol following the symbol that contains the MPDU delimiter has the same MCS as the current symbol. The MCS segmentation field set to 1 may indicate that the symbol following the symbol that contains the MPDU delimiter has an MCS that is one less than the current MCS. The occurrence of more than one MCS segmentation field set to 1 in a symbol may have the same meaning as the occurrence of a single MCS segmentation field set to 1 in the symbol.

In some cases, MCS segmentation may be signaled by defining a 1-bit (or multi-bit) MCS segmentation field in the MPDU header. The MCS segmentation field set to 0 may indicate that the MCS of the symbol following the symbol that contains the MPDU header has the same MCS as the current symbol. The MCS segmentation field set to 1 may indicate that the symbol following the symbol that contains the MPDU header has an MCS that is one less than the current MCS. The occurrence of more than one MCS segmentation field set to 1 in a symbol has the same meaning as the occurrence of a single MCS segmentation field set to 1 in the symbol.

In general, various types of MCS segmentation fields may be utilized. For example, in one aspect of the present disclosure, an MCS segmentation field may be included in a SIG field of a PLCP header or a Service field of a Data field (as illustrated in FIG. 4). In any case, the MCS segmentation field may signal MCS segmentation at a beginning of PPDU. There may be N−1 MCS segments of size |SYM/N| and a final segment with remaining symbols, wherein MCS (index) may be one lower each subsequent segment.

In another aspect of the present disclosure, an MCS segmentation field may be included in a MPDU delimiter or a MAC header. It may signal a start of a new MCS segment in a next symbol. The number of MCS segments may be up to the number of symbols (SYM). The MCS may be one lower for each subsequent segment.

FIG. 5 illustrates example operations 500 for MCS segmentation, in accordance with certain aspects of the present disclosure. The operations 500 may be performed, for example, by a transmitting entity to generate and send a PPDU with MCS segmentation to a receiving entity. The receiving entity may perform complementary operations, parsing the frame to obtain the MCS segmentation field to determine segmentation and process the frame.

At 502, a frame with a data unit may be generated, wherein a field of the frame indicates the data unit being split into segments associated with different modulation coding schemes (MCSs). At 504, the frame may be transmitted.

FIG. 6 illustrates other example operations 600 for MCS segmentation in accordance with certain aspects of the present disclosure. The operations 600 may be performed, for example, by a transmitting entity.

At 602, a frame with a plurality of symbols may be generated, each symbol may comprise one or more data units, wherein one or more fields in the frame may indicate a modulation coding scheme (MCS) of another symbol of the plurality of symbols following that symbol. At 604, the frame may be transmitted.

As noted above, according to certain aspects of the present disclosure, the field of the header may comprise a Signal (SIG) field, and the field of the data unit may comprise a Service field. The frame may comprise a PHY Protocol Data Unit (PPDU). According to certain aspects of the present disclosure, all the segments except one of the segments are of the same size. In an aspect, a quantity of the segments may be specified by a standard or agreed upon when setting up a communication link (during association or establishing a direct link) between apparatuses. The communication link may be established during association between the apparatus and the other apparatus. In yet another aspect, the field of the data unit may specify a quantity of the segments.

In an aspect of the present disclosure, the MCS of a first one of the segments being transmitted within the frame is signaled in the field of the header. In another aspect of the present disclosure, the MCS of a segment of the plurality of segments may be one less than MCS of another segment of the plurality of segments immediately preceding the segment.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 600 illustrated in FIG. 5 and FIG. 6 correspond to means 500A and 600A illustrated in FIG. 5A and FIG. 6A.

For example, means for transmitting may comprise a transmitter, such as the transmitter unit 222 of the access point 110 illustrated in FIG. 2, the transmitter unit 254 of the user terminal 120 depicted in FIG. 2, or the transmitter 310 of the wireless device 302 shown in FIG. 3. Means for receiving may comprise a receiver, such as the receiver unit 222 of the access point 110 illustrated in FIG. 2, the receiver unit 254 of the user terminal 120 depicted in FIG. 2, or the receiver 312 of the wireless device 302 shown in FIG. 3. Means for generating may comprise a processing system, which may include one or more processors, such as the RX data processor 270 and/or the controller 280 of the user terminal 120 or the RX data processor 242 and/or the controller 230 of the access point 110 illustrated in FIG. 2.

Further, in some cases, rather than actually transmit a subframe (or other structure), an entity (e.g., a processor) may output such a structure (e.g., via a bus) to another entity (e.g., an RF front end or modem) for transmission. Similarly, rather than actually receive a subframe (or other structure), an entity (e.g., a processor) may receive such a structure (e.g., via a bus) from another entity (e.g., from an RF front end or modem).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, circuits and circuitry described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
circuitry configured to generate a frame with a data unit, wherein a field of the frame indicates the data unit being split into segments associated with different modulation coding schemes (MCSs); and
a transmitter configured to transmit the frame.

2. The apparatus of claim 1, wherein:
the field is provided in a Signal field of a header of the frame; or
the field is provided in a Service field of the data unit.

3. The apparatus of claim 1, wherein all the segments except one of the segments are of the same size.

4. The apparatus of claim 1, wherein a quantity of the segments is specified in a standard.

5. The apparatus of claim 1, wherein a quantity of the segments is agreed upon when setting up a communication link between the apparatus and another apparatus.

6. The apparatus of claim 1, wherein the field specifies a quantity of the segments.

7. The apparatus of claim 1, wherein an MCS of a first one of the segments being transmitted within the frame is signaled in the field.

8. The apparatus of claim 1, wherein an MCS index of one of the segments is less than that of an MCS index of another segment preceding the segment.

9. The apparatus of claim 1, wherein the frame comprises a PHY Protocol Data Unit (PPDU).

10. A method for wireless communications, comprising:
generating a frame with a data unit, wherein a field of the frame indicates the data unit being split into segments associated with different modulation coding schemes (MCSs); and
transmitting the frame.

11. The method of claim 10, wherein:
the field is provided in a Signal field of a header of the frame; or
the field is provided in a Service field of the header.

12. The method of claim 10, wherein all the segments except one of the segments are of the same size.

13. The method of claim 10, wherein a quantity of the segments is specified in a standard.

14. The method of claim 10, wherein a quantity of the segments is agreed upon when setting up a communication link between an apparatus transmitting the frame and another apparatus.

15. The apparatus of claim 14, wherein the communication link is established during association between the apparatus and the other apparatus.

16. The method of claim 10, wherein the field specifies a quantity of the segments.

17. The method of claim 10, wherein an MCS of a first one of the segments being transmitted within the frame is signaled in the field.

18. The method of claim 10, wherein an MCS index of a segment of the plurality of segments is one less than an MCS index of another segment of the plurality of segments immediately preceding the segment.

19. The method of claim 10, wherein the frame comprises a PHY Protocol Data Unit (PPDU).

20. A wireless node, comprising:
at least one antenna;
circuitry configured to generate a frame with a data unit, wherein a field of the frame indicates the data unit being split into segments associated with different modulation coding schemes (MCSs); and
a transmitter configured to transmit, via the at least one antenna, the frame.
